(19) United States
(12) Patent Application Publication
(10) Pub. No.: US 2019/0180334 A1
(43) Pub. Date: Jun. 13, 2019

(54) AUTOMATED VIDEO PRODUCTION SYSTEMS AND METHODS

(71) Applicant: Magnfi, LLC, Grove City, OH (US)

(72) Inventors: Doug Dibert, Grove City, OH (US); Patrick Tuure, Grove City, OH (US); James Bales, Grove City, OH (US)

(21) Appl. No.: 16/213,723

(22) Filed: Dec. 7, 2018

Related U.S. Application Data
(60) Provisional application No. 62/595,883, filed on Dec. 7, 2017.

(51) Int. Cl. G06Q 30/02; G11B 27/034

(52) U.S. Cl. CPC G06Q 30/0282; G11B 27/034; G06Q 30/0281; G06Q 30/0276

(57) ABSTRACT

Systems and methods for user-guided automated video production, including video testimonials and other forms of branded video content. A user makes video content selections related to audio and visual graphics for a testimonial. Testimonial requests are then sent inviting others to submit videos. Submitted videos are subsequently processed according to the user's selections to produce branded content with features previously dictated by the user. Branded content without testimonials may also be produced based on user selections.

This application is a non-provisional application that claims priority to U.S. Provisional Application No. 62/595,883, filed on Dec. 7, 2017. The entire contents of U.S. Provisional Application No. 62/595,883 are hereby incorporated by reference as if fully recited herein.

### TECHNICAL FIELD

Exemplary systems, devices, and methods are directed to video production, namely, user-guided automated video production.

### BACKGROUND

Customer testimonials are often a strong form of business advertising and marketing. Across many industries, potential customers are interested to know about the experiences of current and former customers before making a decision on whether to buy a product or service. Video testimonials can be particularly persuasive as they lend more authenticity to the testimonial and potential customers may find them more trustworthy than just a written testimonial statement. Branded video content, including content that does not include customer testimonials, can also be a strong marketing tool because it allows potential customers to become familiar with a business and its employees.

It can take a lot of effort and resources for a business to obtain a video testimonial from a customer. Historically, they would need to have the customer come into a production studio and/or send a videographer to the customer's home or another location. The cost to hire professionals to videotape, edit, and produce video testimonials can be high. For many businesses having video testimonials for advertising and marketing efforts is cost-prohibitive. For those companies that do have video testimonials done they often fail to secure new testimonials over time due to cost, meaning that their testimonials may eventually appear outdated and/or irrelevant to viewers. Even without a customer testimonial, the preparation of branded video is also difficult and costly as it nevertheless requires video editing to include logos, business information, music, etc. in a video. Many people lack training and experience in video editing or video production and need to hire professionals in order to create various forms of branded video content.

It is therefore an objective of the present invention to provide systems and methods for securing branded video content, including testimonials, that are effective and easy to use. It is also an objective of the present invention to provide systems and method for automated video creation and production that allow businesses to customize visual graphics and other aspects of the testimonials as desired.

### SUMMARY OF EXEMPLARY EMBODIMENTS

Exemplary embodiments include systems and methods for creating and producing automated video content as guided by a user, including testimonials. An exemplary method for creating automated video content comprises receiving testimonial initiation instructions from a first user, wherein said initiation instructions include one or more video content instructions; transmitting a testimonial request to a second user; receiving a video data file created by a user device associated with the second user; and creating a testimonial video data file, the creation of the testimonial video data file comprising processing the video data file in accordance with the video content instructions. The video content instructions may include an instruction to display a call to action, a selected background audio, or branded content such as displaying a logo. The testimonial video data file may then be provided to the first user. Testimonial instructions may include contact information for the second user, such as an email address.

In an exemplary embodiment, a system for automated video content production includes a processor that is configured to receive testimonial request instructions that include one or more video content instructions; initiate a testimonial request based upon the testimonial instructions, transmit the testimonial request to a user in accordance with the testimonial request instructions; transmit the testimonial request to a user in accordance with the testimonial request instructions; receive a video data file from the user, initiate the creation of a video testimonial using the video data file in accordance with the testimonial request instructions, and issue a notification that the video testimonial is available for download. The video content instructions may identify an audio file that is stored in a database associated with the processor, or identify a visual call to action to include in the video testimonial. The testimonial request may also provide a user with the option to have the request resent after a predetermined time frame (for example, 2 days). Testimonial request instructions may include contact information for the user such as an email address.

An exemplary method for producing branded video content comprises providing a user with a plurality of audio file options and call to action options; receiving from the user a plurality of video content instructions including the selection of an audio file and a call to action; receiving from the user an image file and a video file; and producing a second video file that incorporates the video content instructions, the image file, and video file, and providing the second video file to the user.

### BRIEF DESCRIPTION OF THE DRAWINGS

Novel features and advantages of the present invention, in addition to those mentioned above, will become apparent to those skilled in the art from a reading of the following detailed description in conjunction with the accompanying drawings in which:

FIG. 1 is a system diagram according to an exemplary embodiment;

FIG. 2 is a flowchart illustrating a method of producing a video testimonial according to an exemplary embodiment;

FIG. 3 is a registration screen according to an exemplary embodiment of an automated video production system;

FIG. 4 is an introductory screen according to the exemplary embodiment of FIG. 3;

FIGS. 5A and 5B are a collect testimonial screen according to the exemplary embodiment of FIG. 3;

FIG. 6 is an exemplary customer communication screen according to the exemplary embodiment of FIG. 3;

FIG. 7 is a recording page screen according to the exemplary embodiment of FIG. 3;

FIG. 8 is a post-submission screen according to the exemplary embodiment of FIG. 3;

FIG. 9 is a dashboard screen according to the exemplary embodiment of FIG. 3;

FIG. 10 is a My Videos screen according to the exemplary embodiment of FIG. 3;

FIG. 11 is an Edit Profile screen according the exemplary embodiment of FIG. 3;

FIG. 12 is a Subscription screen according to the exemplary embodiment of FIG. 3;

FIG. 13 is a Purchase Testimonials screen according the exemplary embodiment of FIG. 3; and

FIG. 14 is a branded video naming screen according to the exemplary embodiment of FIG. 3;

FIG. 15 is a branded video instruction screen according to the exemplary embodiment of FIG. 3;

FIG. 16 is a Tutorials screen according to the exemplary embodiment of FIG. 3; and

FIG. 17 is an Affiliate Partnership Program screen according to the exemplary embodiment of FIG. 3.

### DETAILED DESCRIPTION

As set forth in the accompanying figures, disclosed are exemplary embodiments of systems and methods for creating and producing automated video content, including video testimonials and other forms of user-guided branded video content.

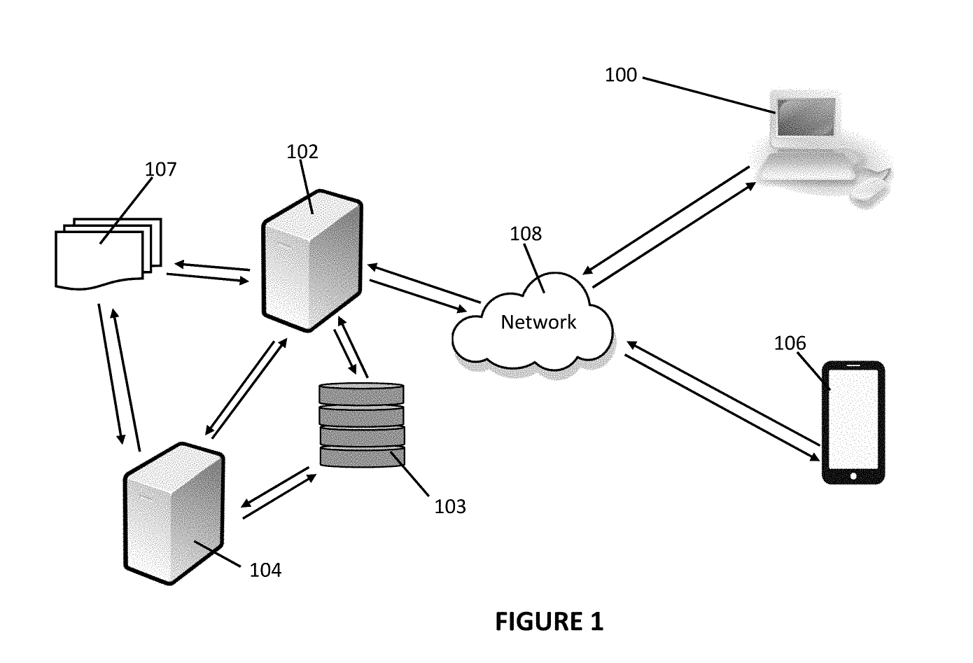

Referring to FIG. 1, an exemplary embodiment a system for producing video testimonials and user-guided branded content. The system is comprised of at least one business user device 100, at least one customer user device 106, a web server 102, and a batch server 104. The user devices 100, 106 communicate with the web server 102 over a network 108. The batch server 104 communicates directly with the web server 102. Via the web server 102, the batch server 104 can communicate with the business user device 100 and customer user device 106.

The web server 102 may support a user interface that allows a user to interact with the system via the network 108. The user interface may be accessible by a number of devices, including at least one business user device 100 and at least one customer user device 106. In an exemplary embodiment, the user interface may be an online portal comprised of multiple web pages that provide users with different functionalities relate to initiation, creation, customization, and management of automated video testimonials. One prominent feature of the user interface may be a video capture wherein a customer user can record a video from a customer user device 106. The web server 102 is in communication with a database 103 that stores a variety of information including application and user data, including user names, login and password information, account information, payment information, and business user preferences and video content instructions. The web server 102 is also in communication with a file share 107 that contains video files, image files, and music files. The file share 107 also stores produced videos. The database 103 and file share 107 may communicate directly with the web server 102 or communicate over a network 108. In some exemplary embodiments the web server 102 may host the database and/or file share 107.

The batch server 104 performs background processing, including video processing and production, as well as related audio processing. The batch server 104 also processes user subscriptions and generates system notifications, which may include email reminders. The batch server 104 may perform processing according to a pre-determined schedule. For example, the batch server 104 may direct the transmission of email reminders to a customer user every two days to notify them that a requested activity not yet been performed. The batch server 104 may also communicate with the database 103 and file share 107 through a direct link or over a network.

The system illustrated in FIG. 1 may be used for created user-generated branded videos, with the exception being that only one user device—the business user device—may need to be utilized. However, one of ordinary skill in the art will recognize that in various embodiments the system architecture could be provided in a variety of ways without departing from the inventive concept. Also, it is possible that a business user could perform certain functions on a first device and other functions on a second or even third device.

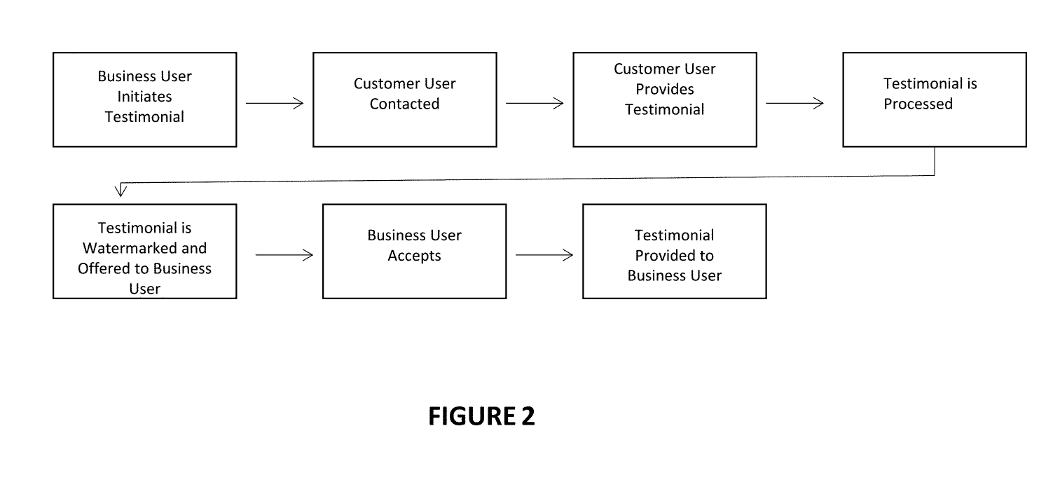

Referring to FIG. 2, a flow chart for an exemplary embodiment of a process for obtaining a video testimonial from a customer user is shown. In this particular embodiment, an initial step is that a business user initiates a testimonial. That is, through the user interface a business user may create an account (or access their existing account) and then enter information identifying a customer user that they wish to request a testimonial from, supplying information such as name and e-mail address. The business user may also identify their preferred features of the testimonial. For example, they may upload a business logo that they would like displayed during the testimonial, select a particular type of background music, write a call to action, identify a phone number and/or email address they would like to appear in the video. In different embodiments, the business user may specify these and other various visual and audio features of the testimonial during this initiation step. These video content instructions and information regarding the customer user may be stored in the database 103.

In a next step, a customer user contact is generated by the web server. The customer user contact presents the customer user with a request to provide a video testimonial. The customer user contact may be made via email, identify who the business user is, and set forth the request for a video testimonial along with instructions on how to record a video testimonial. The request may also contain a link that is keyed to the particular request.

Next, the customer user records and submits a video testimonial. The customer user may record a video using a variety of methods depending on their browser support. Methods may include the use of WebRTC getUserMedia, flash application HDFVR, or the use of an HTML file upload for mobile devices that utilizes the user device's default video capture app. Video files may be in a variety of formats depending upon the capture method of the particular user device, including, but not limited to, FLV, WEBM, MOV, and MP4 files.

Once recorded, the video file may be uploaded to the web server 102, and subsequently transmitted to the batch server 104 for processing by the batch server 104. The batch server 104 may then perform a sequence of steps to prepare a finished video.

An initial step may be a pre-processing step. In the pre-processing step, any audio sync issues with the video file are fixed. Also in the pre-processing step the submitted video file may be converted from whichever file format it was captured in to a digital multimedia format such as MP4 or MPEG-4 Part 14. The conversion of the file format may be performed to standardize subsequent processing.

Next, an audio normalization step may be performed to ensure that the sound on the video data file is not drowned out by any background music files. This may be performed by scaling the audio such that it is never any quieter than the music.

A production step may then be performed whereby the captured video is combined with desired audio and visual features in order to create the finished video testimonial file. These manipulations may be dictated by the video content instructions previously selected by the business user. For example, a company user's logo may be added to the video. The logo may be displayed at the beginning of the testimonial or the end of the testimonial, or at any other time or times during the video as desired. Fading effects may be added to the start and/or end of the video, to enhance the viewer experience. For example, there may be a white or black fade out at the beginning and/or end of a testimonial video. A call to action may also be added to the video. The call to action may be presented on the video along with a phone number or other information at a predetermined location. Background music may also be added to the entire video. In alternative embodiments background music may be added to only sub-portions as desired. If the video data file was taken on a cell phone or other user device with a “portrait mode”, blurring along the sides of the video may be done to enhance the appearance of the video when viewed on a computer screen.

The production step, particularly the video manipulations, may be performed through the use of FFmpeg, directed by MovieMasher. Audio manipulations may be achieved with a multitrack audio processing tool such as Ecasound. During the production step, MovieMasher may receive one or more files in JSON data format and translate the JSON file(s) into a series of FFmpeg and Ecasound commands to allow for the manipulation of audio and video files. One of ordinary skill in the art will recognize that there are other types of video editing and processing software that may be used to perform different aspects of the production step.

After the production step, a post-processing step may be performed. In the post-processing step, the volume of any background music may be tapered off at the end of the video to create a “fade out” effect. Other final adjustments may also be performed. At the end of the post-processing step the video file is in final form.

After the post-processing step, the video file may be copied and the copy given a watermark. The watermarked version of the video may be offered to the business user (or any other potential purchaser) as part of a message informing the business user that the video is ready for viewing. After the business user views the video they may decide if they wish to purchase the video. If they accept, they may enter their payment information via the user interface. Once payment is received the finished video file (without a watermark) will be made available to them via the user interface. The user may be provided with a video file that they can download, or the user may receive a link that they can cut and paste in order to embed the video into the user's website, social media, or other online materials.

One of ordinary skill in the art will recognize that the processing and production steps described above refer to only a single exemplary embodiment, and that in various embodiments the steps may different in order or function. In one exemplary embodiment, such as one where branded videos or M-Link videos are being created, the watermarking step may occur after audio normalization allowing a user to view a watermarked version of the video prior to production and give their approval before the system is instructed to proceed with the remaining production steps. In other exemplary embodiments various steps may be initiated only upon receiving confirmation that a user approves of a video, or that the user has properly subscribed and/or paid and is entitled to a fully produced video.

Referring back to FIG. 1, the business user device 100 and customer user device 106 may be a variety of electronic devices including personal computers, smart phones, tablets, and other personal computing devices that can access the user interface over the network 108. Customer user devices 106 may be those that have built-in web cams or other video taking functionality, or detachable camera devices that are compatible with the user devices.

While FIG. 1 displays a single web server 102 and single batch server 104, one of ordinary skill in the art will recognize that multiple web servers and multiple batch servers can be utilized to perform the same functions described herein on a larger scale. Furthermore, the system may support a multitude of business user and customer users associated with a multitude of user devices.

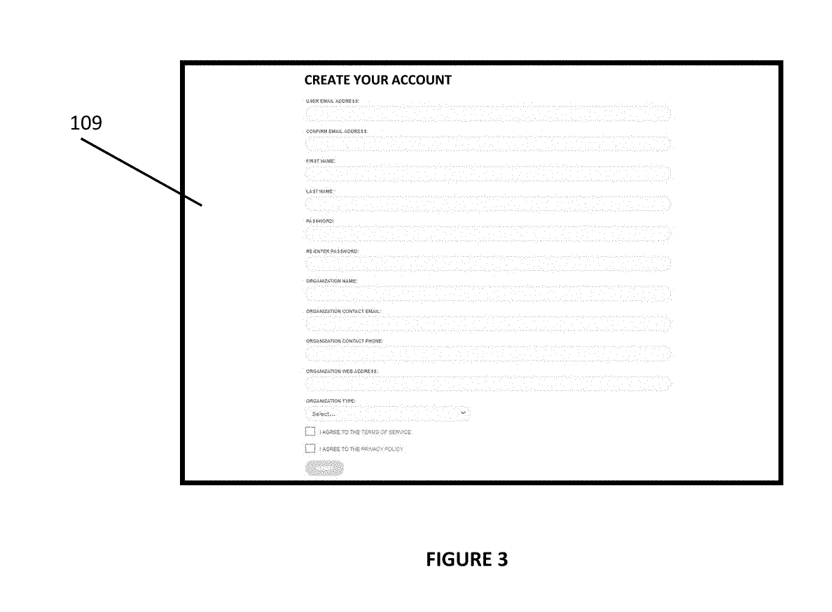

FIGS. 3-17 illustrate a user interface of an exemplary embodiment. Referring to FIG. 3, a registration screen 109 according to an exemplary embodiment is shown. The registration screen 109 may allow a business user to create an account. Basic information such as email, contact names, organizational info, type of information, password, and more. A business user can also use check boxes to confirm their agreement with any terms of service, privacy policy, or any other notices or agreements.

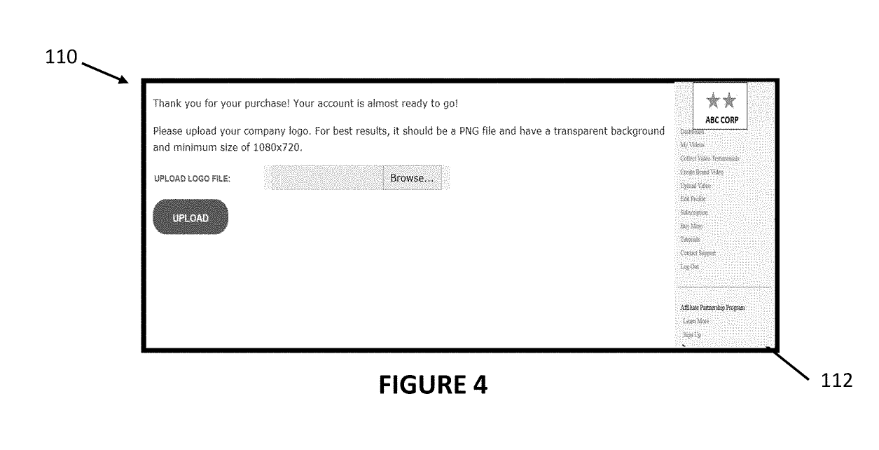

Referring to FIG. 4, an exemplary introductory screen 110 according to an exemplary embodiment of an automated video testimonial system is shown. The introductory screen may be presented to a business user by the system once the business user has been registered into the system. As shown in FIG. 4, the introductory screen may request that the business user upload a company logo for eventual display in a video testimonial or other form of branded video. The introductory screen may set forth requirements for logo files, including formats and size. A menu bar 112 may help the user navigate between different screens that provide a variety of function. For example, the menu bar may have links to screens that allow the user to adjust profile settings, view current testimonials, collect testimonials, edit their subscription, view tutorials, contact support, and log out of the system. Other functions may also be performed through use of the menu bar 112. If a user clicks on “contact support” they may either be directed to a page containing contact information for a support team, or they may initiate the creation of an email message via Outlook or another email program on their user device that will be sent to the support team.

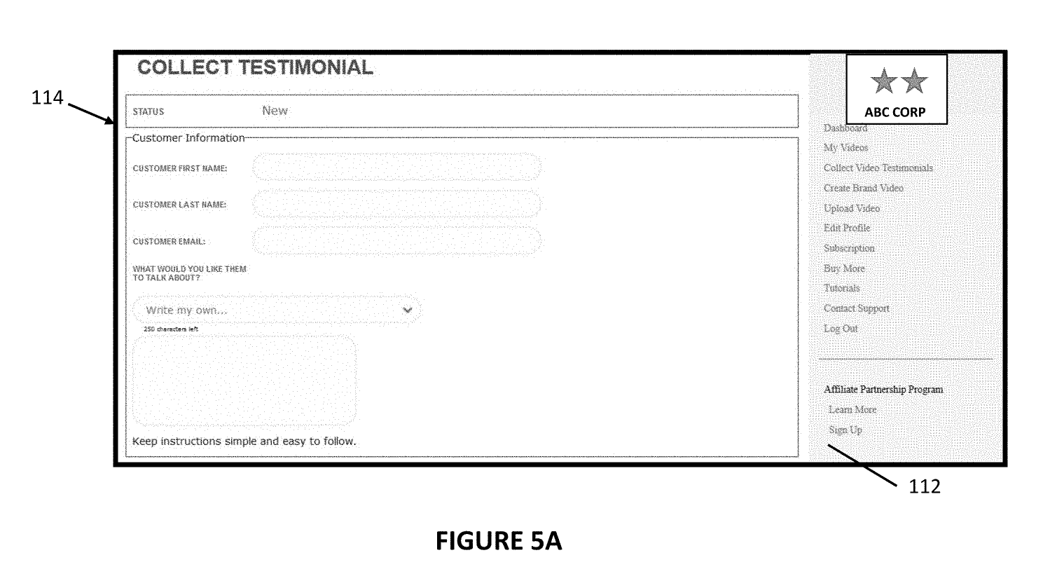

Referring to FIGS. 5A and 5B, an exemplary collect testimonial screen 114 according to the exemplary embodiment of FIG. 3 is shown. In this exemplary embodiment, the uploaded business logo for “ABC Corp” is displayed on the testimonial screen 114 above the menu bar 112. The collect testimonial screen allows the business user to customize and dictate various features for a potential video testimonial. General information about the customer user may be entered including their name and email. The business user can provide instructions on what they would like the customer user to talk about, helping to guide the customer user to what might be most beneficial to the business user in the potential video testimonial.

The collect testimonial screen 114 may next allow the business user to pick to select from a dropdown list the type of background music that they would like to play during the testimonial. Music can also be previewed by the business user to confirm that it is desirable by playing an audio file. The business user may then select the option to include a “call to action” on the video testimonial. A call to action may be a written statement that is visually presented on the testimonial and solicits an action from a viewer. For example, a call to action may ask the viewer to call the business (such as “Call Now”), check the business' website, and/or list any relevant phone numbers, email addresses, or website urls. Several pre-determined types of call to actions may be selected from a dropdown list, or a business user may decide to create their own custom call to action and have the call to action state whatever they desire. As shown on the screenshot of FIG. 5B, check boxes may be selected to automatically add a phone number or email address. The screen may also display a “call to action preview” 116 so that the business user can view what the selected call to action will look like and adjust appropriately. In some embodiments, the business user may be able to adjust additional features such as the color and/or font style of the call to action.

Once the business user enters contact information for a customer user, sets the video contents, and hits “save,” the system will save all information in the database 103 and initiate a notification for the identified customer user.

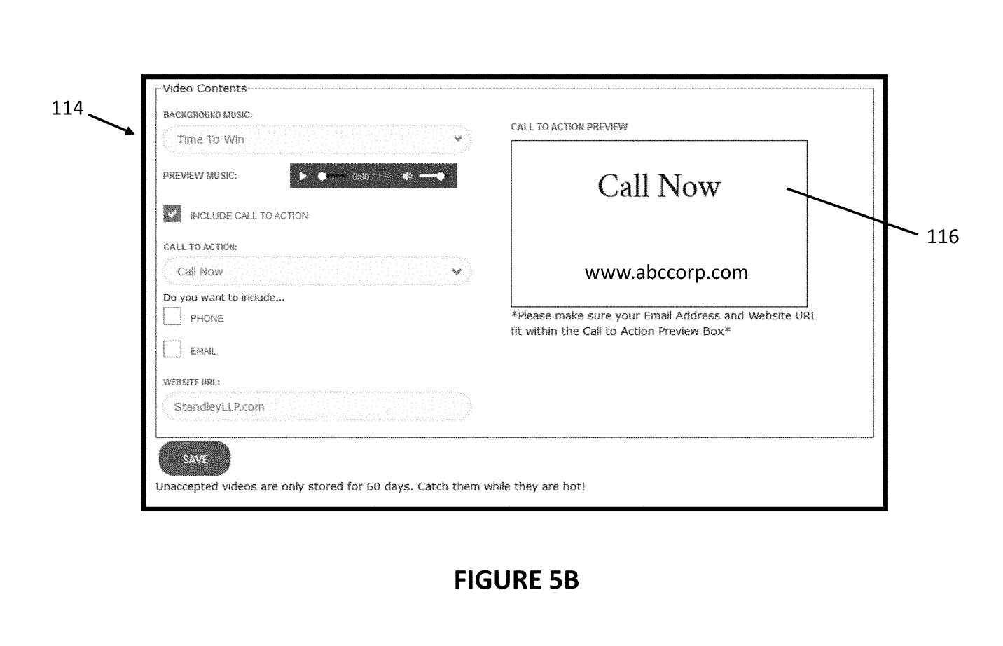

Referring to FIG. 6, an exemplary solicitation message 118 according to the exemplary embodiment of FIG. 3 is shown. The solicitation message 118 is a notification that may be transmitted to the identified customer user, and request that the customer user record a video testimonial. The message may provide basic instructions about how to record the video. The message may also include a video that shows how to take the video. The message may be sent by email using the email information previously entered by the business user. In other exemplary embodiments, the solicitation message may be sent via text message upon the entering of the customer user's phone number into the system. If the customer user is interested in fulfilling the request to record a video testimonial, the customer user may select a “start” button to begin the process.

The system may be configured to send intermittent reminders to a customer user that if they do not submit a video within a certain amount of time after receiving a request, For example, 3 days. As shown in FIG. 6, the solicitation message itself may provide the user with the option to delay their submission of a video and request a reminder in a predetermined time, for example, in 2 days.

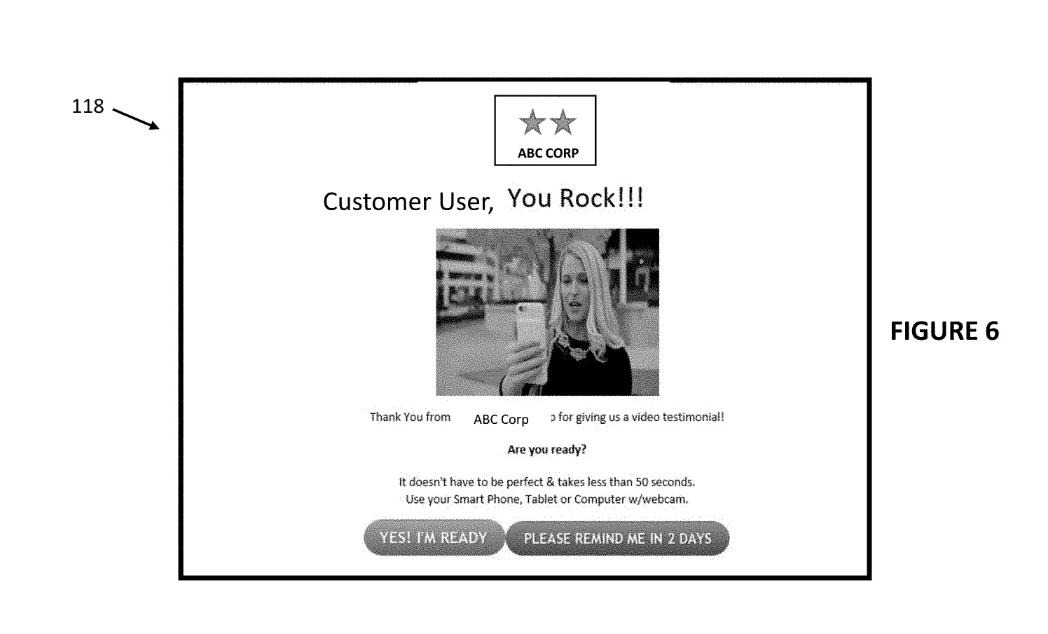

Referring to FIG. 7, an exemplary recording page 120 according to the exemplary embodiment of FIG. 3 is shown. This page allows a customer user to record their testimonial, play it back to ensure they approve, and submit it once its approved. On the recording page 120 is a video screen 122 that shows the customer user what their video looks like in real-time as they record, and later if they play it back. Videos are recording using existing camera and microphone technology on the customer user's user device. For example, the camera and microphone on a smart phone or a camera and microphone on a laptop that is either built-into the device or connected for purposes of making the recording. As shown in FIG. 7, the recording page 120 may include instructions regarding how to do the video, as well as suggestions for the testimonial that the business user entered into the collect testimonial screen 114. The recording page may show a countdown of time until the video will stop recording, to help ensure that the customer user does not get cut off.

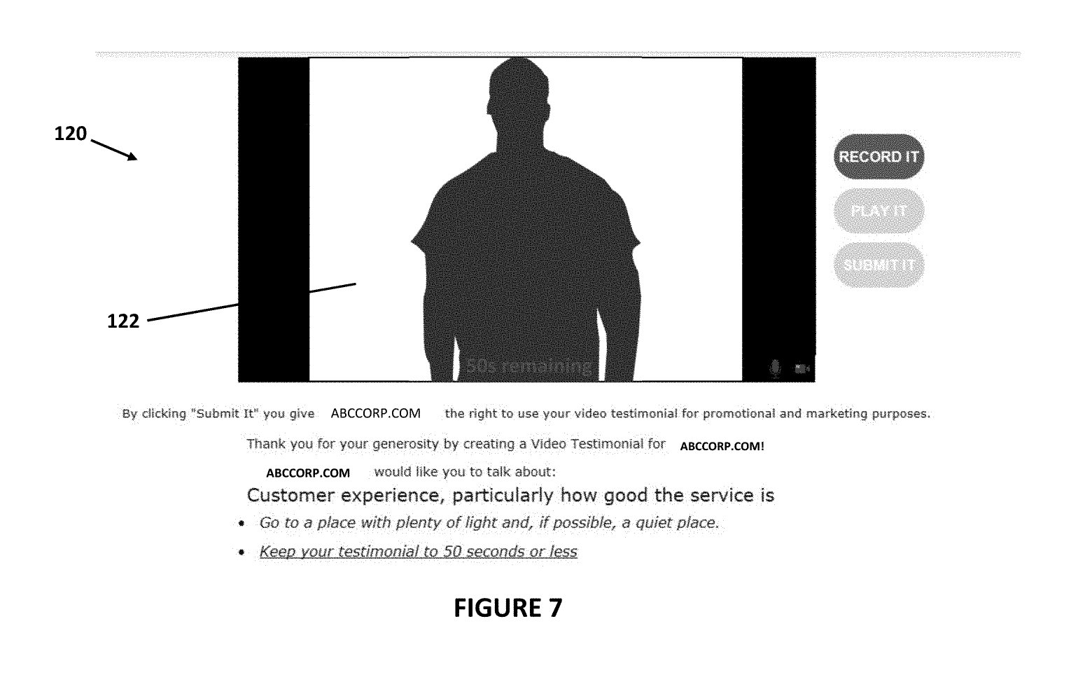

Referring to FIG. 8, an exemplary embodiment of a post-submission screen 124 that may appear after a customer user has submitted their testimonial video is provided. This screen may confirm to a customer user that their video has been completed and uploaded.

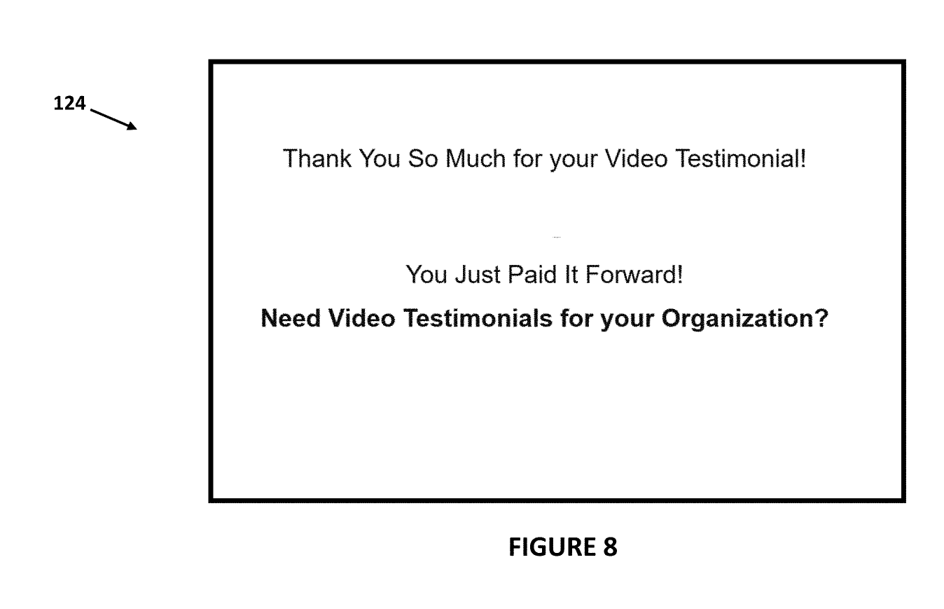

After a testimonial video has been submitted, a business user may receive a notification that they have a testimonial ready for approval and posting via email or other means. The business user may log into the program and check their “dashboard.” Referring to FIG. 9, an exemplary dashboard screen 128 according to the exemplary embodiment of FIG. 3 is shown. The dashboard screen 128 may display information to the business user regarding how many testimonials they have waiting to be reviewed, how many are waiting to be downloaded, how many video credits they have on their current subscription, and the link needed to post testimonials that are ready to their website, social media, or other location. The dashboard screen 128 may also provide useful information to the business user such as how many days the testimonials are stored for before the links will expire. As shown in FIG. 9, the dashboard screen 128 may also contain the menu bar 112 to assist users with navigating around the system.

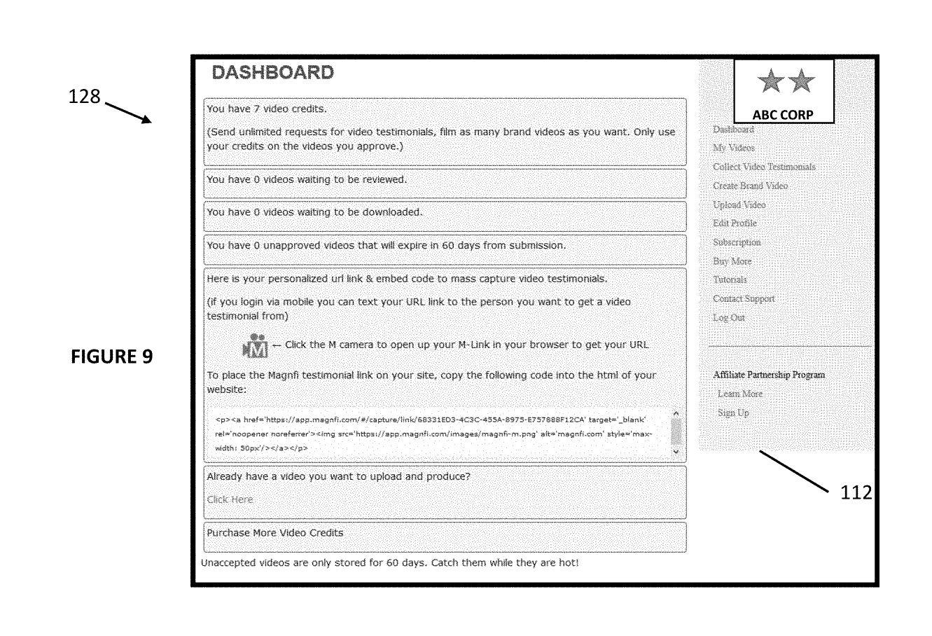

Referring to FIG. 10, an exemplary “My Videos” screen 130 according to the exemplary embodiment of FIG. 3 is shown. The My Videos screen 130 displays status information of both requested testimonials and link submissions. It may also include information about any brand videos. For all videos identified on the My Videos screen 130, information provided may include video status, customer name (or video name for brand videos) and expiration information. The My Videos screen may also display information regarding how many days videos are stored by the system before they are purged from the system. As shown in FIG. 10, the My Videos screen 130 may also contain the menu bar 112.

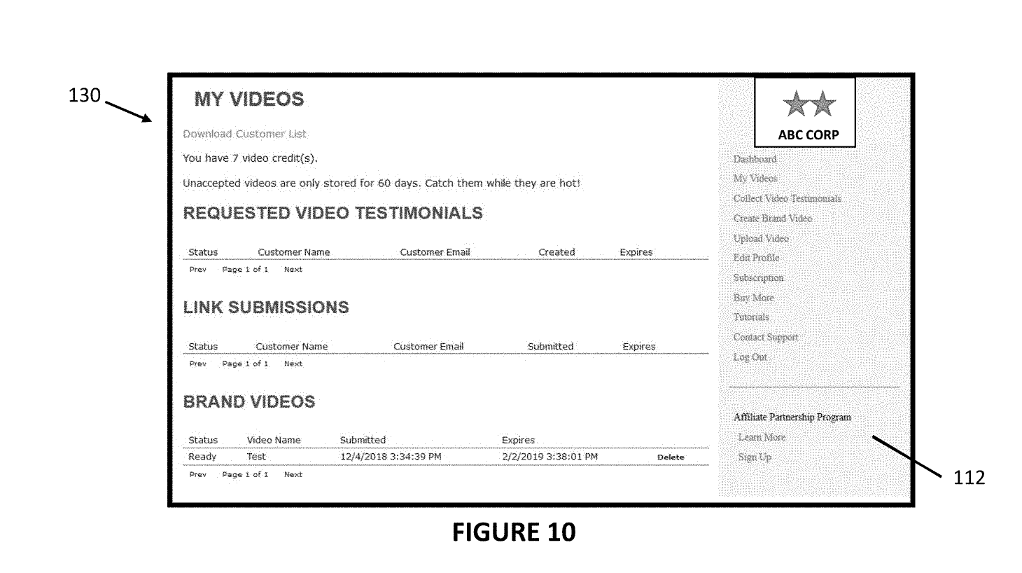

Referring to FIG. 11, an exemplary Edit Profile screen 132 (or “Account Details”) is shown. The Edit Profile screen 132 displays a business user's account details, including basic information such as email addresses, website address, organization type, and the logo to be displayed in created videos. The Edit Profile screen 132 may also allow a user to change any of their profile information, including their logo and/or password. The Edit Profile screen 132 may allow a user to view and update and/or change any type of information at all associated with their profile. As shown in FIG. 11, the Edit Profile screen 132 may also include the menu bar 112.

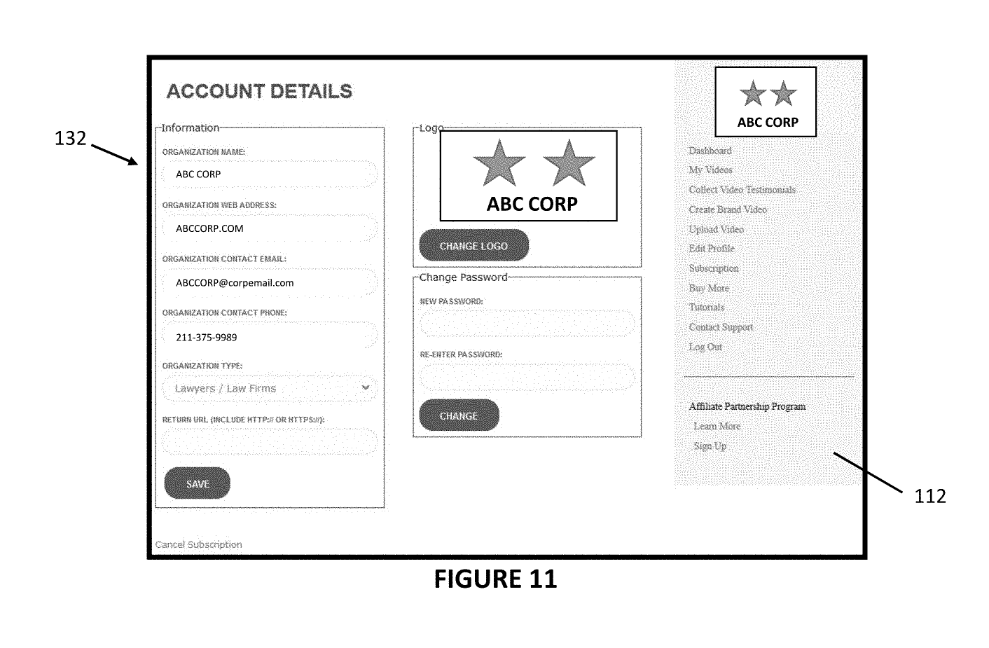

Referring to FIG. 12, an exemplary Subscription screen 134 according to the exemplary embodiment of FIG. 3 is shown. The Subscription screen 134 allows a user to confirm their current subscription and make a subscription payment if desired. This page may also allow a user to update their payment information and/or sign up for automatic payments. The Subscription screen 134 may also include the menu bar 112. As illustrated in FIG. 12, there may be various subscription options for users to choose from, which may set different amounts of video credits to be used during a certain time frame.

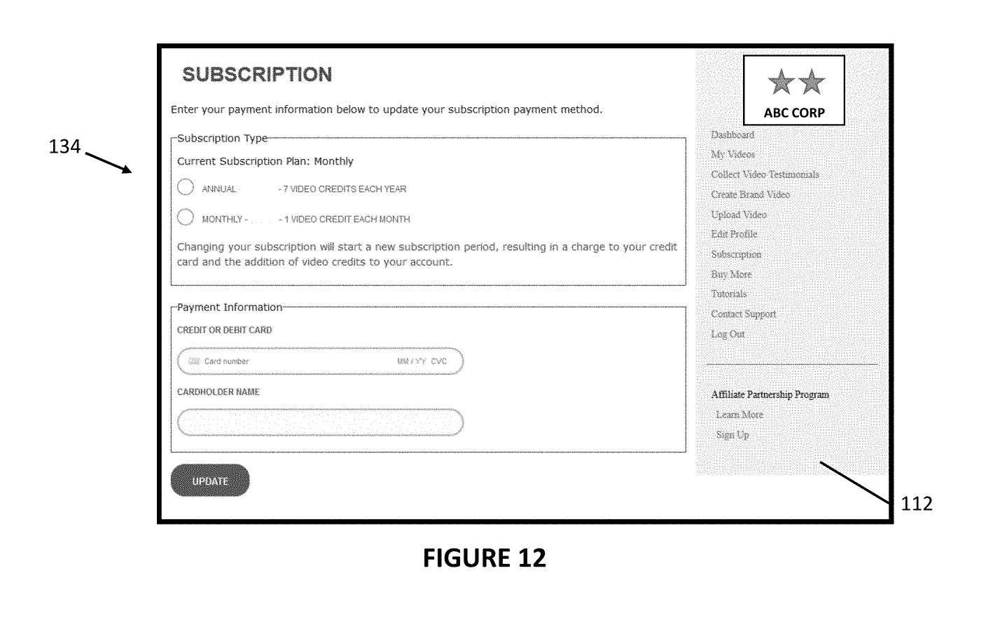

Referring to FIG. 13, a Purchase Testimonials screen 136 according to an exemplary embodiment is shown. The Purchase Testimonials screen 136 allows a user to select a video package (a certain number of testimonials) and pay for them. The Purchase Testimonials screen 136 may also include the menu bar 112.

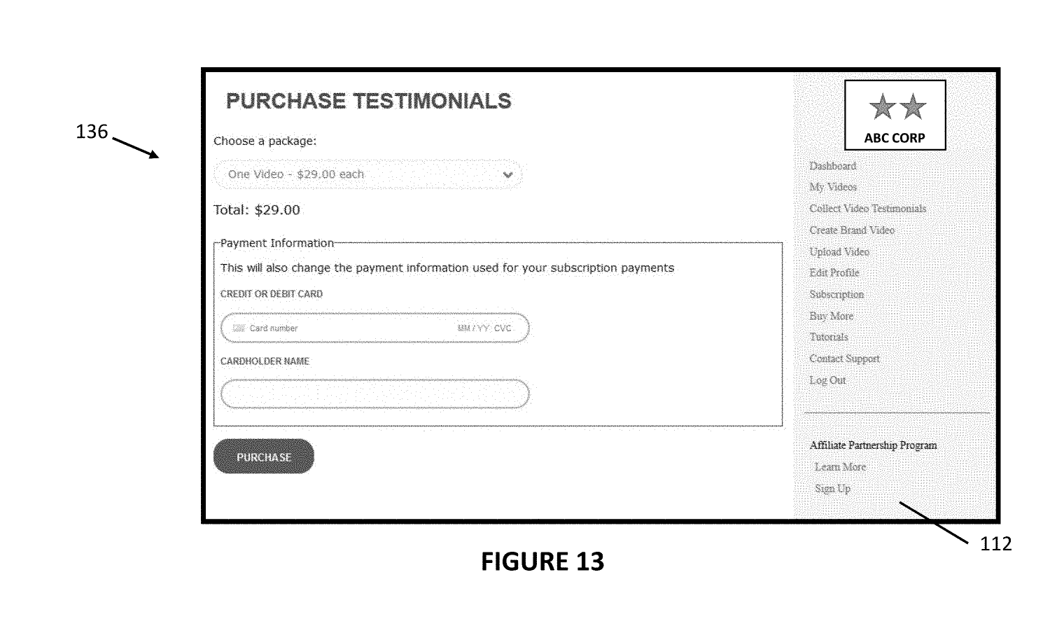

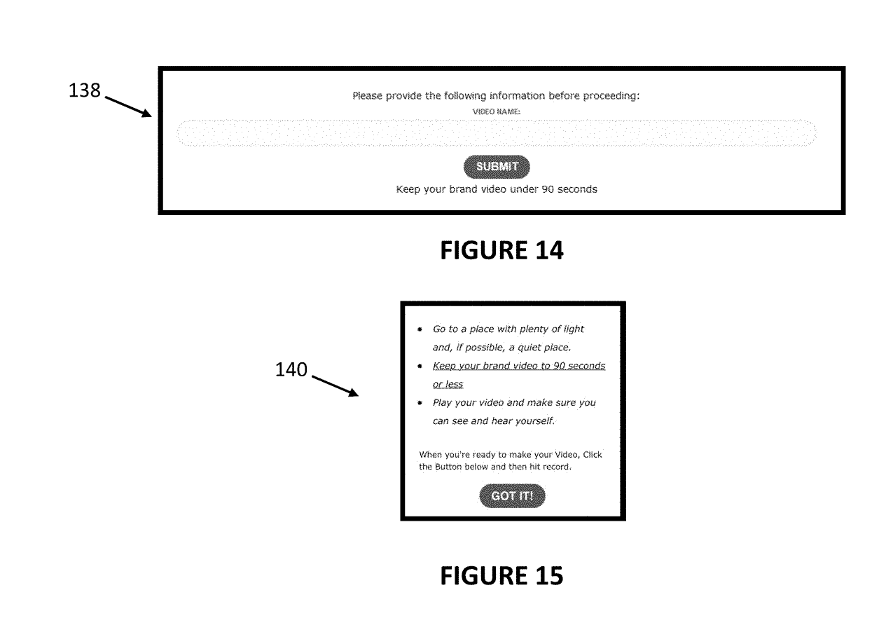

Referring to FIG. 14, an exemplary embodiment of a screen for entering a name for a brand video 138 is shown. A user can name the video as desired and then submit. Once they submit the name, the user may see a screen giving them instructions on how to shoot the video. An exemplary embodiment of a video instruction screen 140 is shown in FIG. 15. The user may then take a video using a variety of devices, which may include cell phones, tablets, or a variety of other personal computing devices. Once completed the user may confirm submission of the video. The user may also have the option to view the video and retake the video before submission.

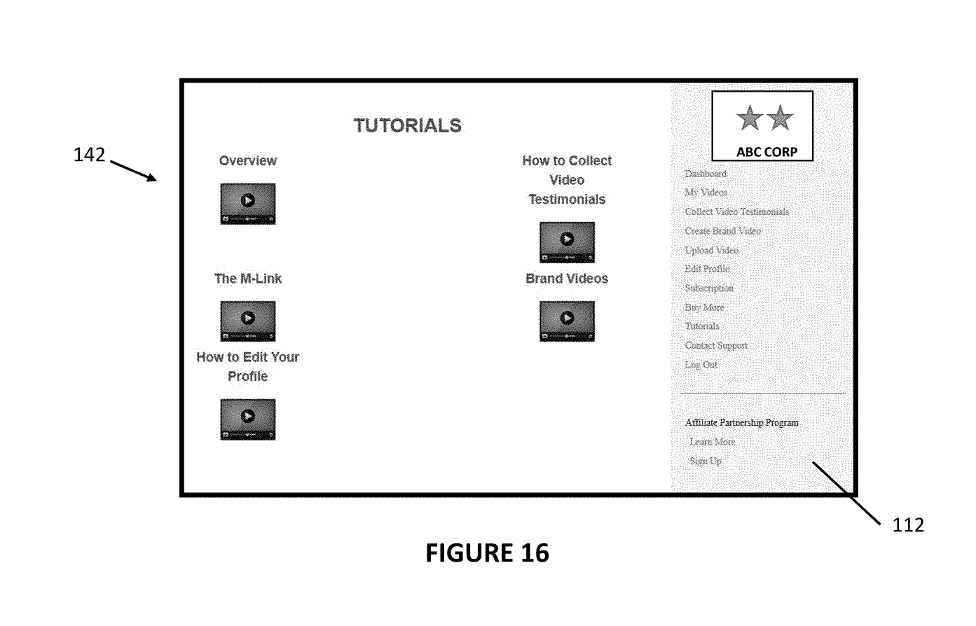

Referring to FIG. 16, an exemplary Tutorials screen 142 according to an exemplary embodiment of FIG. 3 is shown. The Tutorials screen 142 provides a business user with video tutorials showing the user how to perform certain functions. Examples of tutorial topics may include a complete walkthrough of the system, how to edit a profile, how to manage My Videos, how to collect a testimonial, and information on M-Links. Information may also be presented to a user via written text, such as a “Facts” or “Questions & Answers” section. The Tutorials screen 142 may also include the menu bar 112.

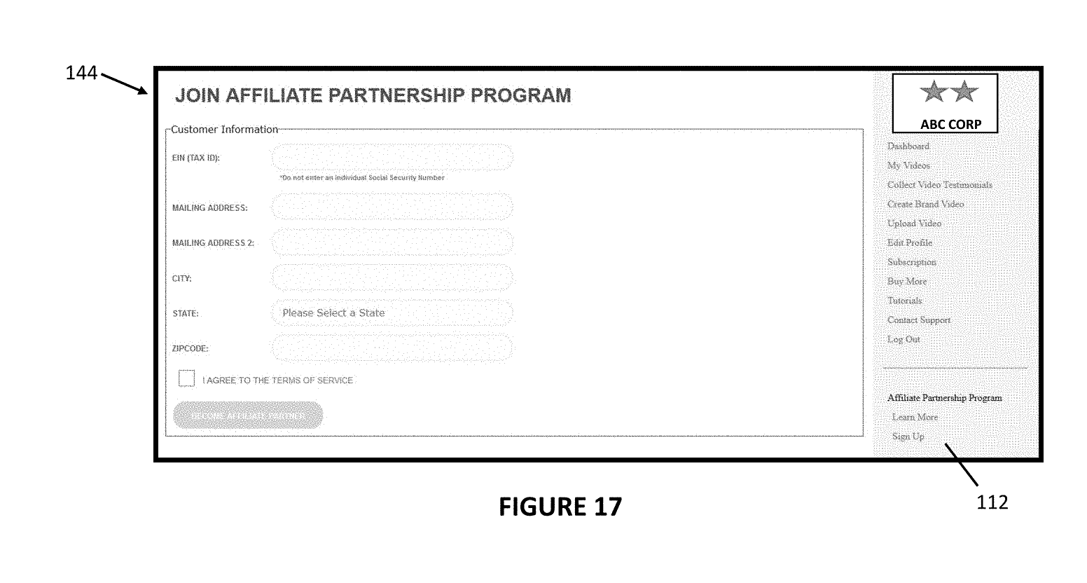

Referring to FIG. 17, an exemplary Affiliate Sign Up screen 138 is shown. This screen may allow an interested user to become an affiliate.

It will be appreciated by one of ordinary skill in the art that additional screens pertaining to a variety of topics may be incorporated into the system. Furthermore, the layout and content of each of the screens may vary without departing from the inventive concept.

In an alternative embodiment, M-Links are used to request and submit mass amounts of testimonials. An M-Link is unique to the business user's account and capable of capturing multiple videos for the account from multiple users. A business user transmits an M-Link embedded code in an email to multiple customer users, or places the M-Link on their website or other online content, seeking testimonials. A business user may even send the M-Link via text message. Multiple customer users may click on the M-Link to begin the process of submitting video testimonials. The user's name and email address is captured to identify the particular user that has selected the M-Link. The use of the M-Link prevents the business user from having to generate unique URL links for each customer user. All videos submitted via the M-Link will be presented to the business user on their dashboard for review and approval. In an exemplary embodiment, videos submitted via M-Link may not be fully processed when posted to the dashboard, but only have a watermark on them. In such embodiments the videos submitted via M-Link will be fully processed into final video files after they are selected by the business user and/or paid for. This embodiment may allow a business user to view many potential videos before having to chose which ones to pay for and have processed into final form. In other exemplary embodiments, the videos submitted via M-Link may be fully processed, or even semi-processed when they are posted to the business user's dashboard. M-Link return URLS can also be used to communicate with customer users that submitted videos and even send them specific links to promotions or advertisements.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

1. A method for creating automated video content, comprising:
receiving testimonial initiation instructions from a first user, wherein said initiation instructions include one or more video content instructions;
transmitting a testimonial request to a second user;
receiving a video data file created by a user device associated with said second user; and
creating a testimonial video data file, said creating of said testimonial video data file comprising processing said video data file in accordance with said video content instructions.

2. The method of claim 1, wherein said one or more video content instructions includes an instruction to display a call of action.

3. The method of claim 1, wherein said one or more video content instructions include an instruction for background audio.

4. The method of claim 1, wherein said one or more video content instructions includes an instruction for branded content.

5. The method of claim 1, further comprising the step of:
providing said testimonial video data file to said first user.

6. The method of claim 1, wherein said testimonial initiation instructions include contact information for said second user.

7. A system for automated video content production, comprising:
a processor associated with a web server, said processor configured to:
receive testimonial request instructions, said testimonial request instructions including one or more video content instructions;
initiate a testimonial request based upon said testimonial instructions;
transmit said testimonial request to a user in accordance with said testimonial request instructions;
receive a video data file from said user;
initiate the creation of a video testimonial utilizing said video data file in accordance with said testimonial request instructions; and
issue a notification that said video testimonial is available for download.

8. The system of claim 7, wherein said video content instructions identify an audio file that is stored in a database associated with said processor.

9. The system of claim 7, wherein said video content instructions identify a visual call to action.

10. The system of claim 7, wherein said testimonial request provides said user with option to have said testimonial request resent after a predetermined time frame.

11. The system of claim 7, wherein said testimonial request instructions include contact information for said user.

12. The system of claim 12, wherein said contact information includes an email address.

13. A method for creating branded video content, comprising:
providing a user with a plurality of audio file options;
providing a user with a plurality of call to action options;
receiving from said user:
a plurality of video content instructions, said plurality of instructions comprising at least one audio file selection from a plurality of audio file options and at least one call to action selection from a plurality of call to action options;
an image file;
a first video file;
producing a second video file, wherein said second video file incorporates said plurality of video content instructions, said image file, and said first video file; and
providing said second video file to said user.

14. The method of claim 13, wherein said creation of said second video automatically occurs upon receipt of said first video file.
